(19) United States
(12) Patent Application Publication
(10) Pub. No.: US 2013/0100484 A1
(43) Pub. Date: Apr. 25, 2013

(54) Public Network Printing System

(71) Applicants: John L. Hankins, Lafayette, CO (US); Gene Spinelli, Divide, CO (US); Brian P. Doyle, Boulder, CO (US)

(72) Inventors: John L. Hankins, Lafayette, CO (US); Gene Spinelli, Divide, CO (US); Brian P. Doyle, Boulder, CO (US)

(21) Appl. No.: 13/279,996

(22) Filed: Oct. 24, 2011

(51) Int. Cl. G06F 15/00

(52) U.S. Cl. 358/1.15

(57) ABSTRACT

A printing system includes a client printing network, a third-party printing network and a cloud computing server coupled to the client printing network and the third-party printing network. The cloud computing server includes a workflow engine to receive print job data from the client printing network, download the print job data to the client printing network if the print job data indicates that it is to be printed at the client printing network and download the print job data to the third-party printing network if the print job data indicates that it is to be printed at the third-party printing network

### FIELD OF THE INVENTION

The invention relates to the field of computer systems, and in particular, to processing print jobs received from a public network.

### BACKGROUND

Printers are common peripheral devices attached to computers. A printer allows a computer user to make a hard copy of documents that are created in a variety of applications and programs on a computer. In some cases the program, such as a billing application, can generate very large files which are printed on large, high speed digital printers. In the case of transaction oriented applications, such as billing, the print output must go through an additional post-printing process to separate the file into individual documents that are then placed in envelopes and mailed to the relevant individuals. Maintaining privacy and accuracy are key aspects of this process. To function properly, a channel of communication is established (e.g., via a network connection) between the printer and the computer to enable the printer to receive commands and information from the host computer. It is also the case that many organizations which must send transaction documents to individuals elect to send some or all of the application output to an external print service provider who then does the printing and mailing.

In some instances, the computer running the application sends the file to a second computer running programs which provide a number of functions designed to enhance the printing and post-printing process. These programs can be quite expensive and complex and such printing software is typically available as a licensed product to large organizations having large, high speed printing facilities.

However, complex printing software may not be available to smaller organizations that do not have sufficient capital budget to license, or technical support resources to operate, the printing software, although implementation of the software would be beneficial.

Accordingly, a cloud computing printing service is desired that allows the smaller organization to have access to this software and avoid the capital cost and technical issues incurred in the license model.

### SUMMARY

In one embodiment, a print server is disclosed. The print server includes a workflow engine to receive print job data via a cloud computing network, download the print job data to a local print server in a client printing network if the print job data indicates that it is to be printed at the client printing network and download the print job data to a local print server in a third-party printing network if the print job data indicates that it is to be printed at the third-party printing network

Another embodiment discloses a method that includes receiving print job data at a cloud computing network server, determining if the print job data is to be printed at a printer within a client printing network or a printer within a third-party printing network, downloading the print job data to a local print server in the client printing network if the print job data is to be printed at the client printing network and downloading the print job data to a local print server in the third-party printing network if the print job data is to be printed at the third-party printing network.

### BRIEF DESCRIPTION OF THE DRAWINGS

A better understanding of the present invention can be obtained from the following detailed description in conjunction with the following drawings, in which:

FIG. 1 illustrates one embodiment of a cloud hosted print data processing system network;

FIG. 2 illustrates one embodiment of a primary server.

FIG. 3 is a flow diagram illustrating one embodiment of processing print jobs using a cloud computing network; and

FIG. 4 illustrates one embodiment of a computer system.

### DETAILED DESCRIPTION

A cloud computing printing service is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

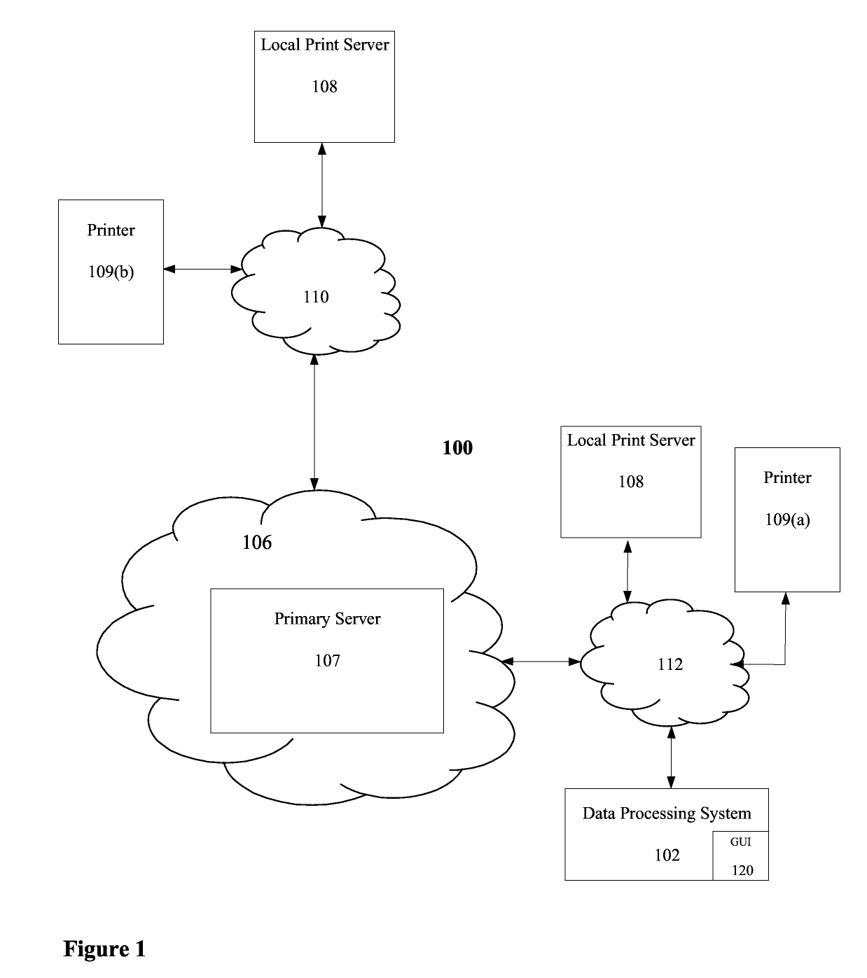

FIG. 1 illustrates one embodiment of a data processing system network 100. Network 100 includes networks 110 and 112 coupled to a network 106. According to one embodiment, network 106 is a public network, such as the Internet or cloud computing network, while networks 110 and 112 are local area networks (LANs). In such an embodiment, networks 110 and 112 each include a local print server 108 to receive print requests from primary server 107 via network 106.

In one embodiment, a local print server 108 downloads processed pages of print job data from primary server 107 via a Virtual Private Network (VPN) for printing at one or more printers 109 within the network. In a further embodiment, a local print server 108 receives the print job data from network 106 via a Virtual Private Network (VPN) and distributes the jobs to the designated printers 109. In yet a further embodiment, local print server 108 within network 110 is implemented to receive and process print jobs on behalf of a third-party organization (e.g., a Print Service Provider). Thus, networks 110 and 112 may be referred to as third-party printing service and client printing networks, respectively. In other embodiments, local print server 108 within network 112 may be implemented as a simple print driver that directs print jobs to printers 109 in network 112.

Client printing network 112 also includes a data processing system 102, which is typically a medium to large data processing system, coupled to network 106. In one embodiment, data processing system 102 is a conventional data processing system including a processor, local memory, nonvolatile storage, and input/output devices such as magnetic disk or optical disc and its corresponding drive may also be coupled to computer system 400 and the like, all in accordance with the known art.

In one embodiment, data processing system 102 includes and employs the MVS operating system or a similar operating system and/or network drivers permitting data processing system 102 to communicate with network 106 for the purposes of employing resources within network 106. In a further embodiment, an operator at data processing system 102 may interact with primary server 107 via a graphical user interface (GUI) 120 in order to provide for efficient transmission of print jobs. Particularly, GUI 120 provides an operator console that enables capabilities such as the scheduling of print jobs, reporting on job status, automated reprints, and application of a variety of optional processes during the workflow process (e.g., conversion of the file format, and reprint management).

According to one embodiment, primary server 107 is a cloud server that receives print requests from data processing system 102 and serves print requests via network 106 to one or more printers 109 within each of networks 110 and 112. Thus, an operator at client network 112 may designate print job documents to be produced at their own network 112 or the third-party printing service network 110.

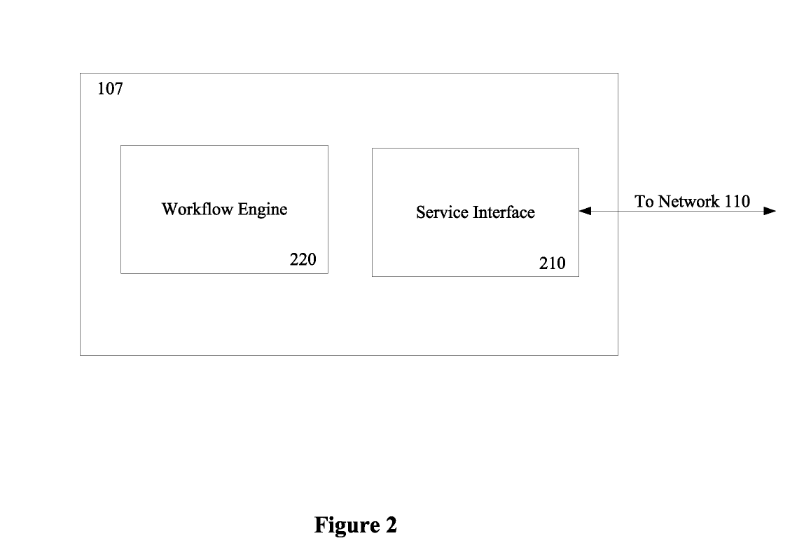

FIG. 2 illustrates one embodiment of primary server 107. Primary server 107 is a worklflow server that includes a service interface 210 and a workflow engine 220. In one embodiment, service interface 210 provides an interface between primary server 107 and local print server 108 at network 110. Particularly, interface 210 provides a status to print server 107 for all jobs being printed at printers 109 within network 110. Service interface 210 may be implemented using either a file based or web services architecture.

Workflow engine 220 is a printing software product that manages the printing of documents received from data processing system 102 at one or more of printers 109 in either network 110 or 112. In one embodiment, workflow engine 220 may be implemented using either InfoPrint Manager (IPM) or InfoPrint ProcessDirector (IPPD), although other types of printing software may be used instead.

As discussed above, GUI 120 provides a workflow engine console that enables an operator to interface with workflow engine 220 to select from among available print and reporting options. In a further embodiment, the workflow engine console displays all print resources available to the operator.

According to one embodiment, workflow engine 220 enables an operator to define resources to be used for print jobs. For instance, an operator may select whether a print job is to be printed at a particular within the operator's network, or delivered to the third-party printing service network 110 for printing. In a further embodiment, workflow engine 220 may automatically direct print jobs based on particular job types. For example, all print jobs received as Portable Document Format (PDF) files are automatically forwarded to the third-party printing service network 110 for printing, or that print job types having a pre-defined name will be printed at printer 109 in network 112.

In one embodiment, the workflow engine console displays the current status of all print jobs in progress, regardless of whether the job is being printed at an in-house printer 109 within client printing network 112 or the third-party printing service network 110. Additionally, reprint and inserter status may also be displayed at the workflow engine console in order to provide information regarding reprint and inserter (e.g., documents being inserted into an envelope) actions at a printer 109.

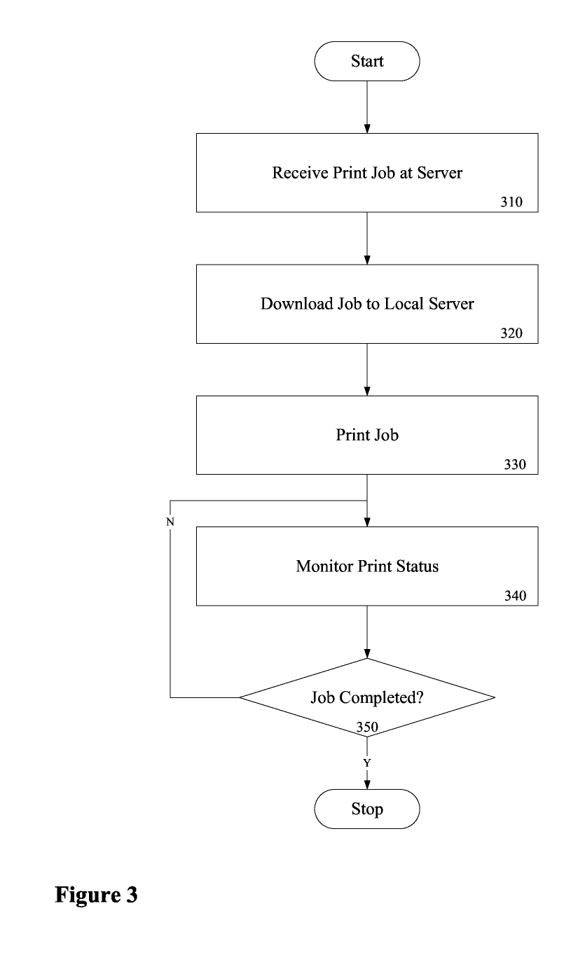

FIG. 3 is a flow diagram illustrating one embodiment of processing print jobs using a cloud computing network. At processing block 310, print jobs are received at workflow engine 220 from a data processing system 102. In one embodiment, a print job request includes the destination (e.g., network 110 or a local printer 109) at which the job is to be produced.

In a further embodiment, print job requests are presented using the Advanced Function Presentation (AFP™) system developed by International Business Machines Corporation. According to the AFP system, documents may include combinations of text, image, graphics, and/or bar code objects in device and resolution independent formats. Documents may also include and/or reference fonts, overlays, and other resource objects, which are required at presentation time to present the data properly. In AFP a Mixed Object Document Content Architecture (MO:DCA) data stream is provided to primary server 107.

According to one embodiment, the AFP MO:DCA data streams are object-oriented streams including, among other things, data objects, page objects, and resource objects. Primary server 107 processes pages of output that mix all of the elements normally found in presentation documents (e.g., text in typographic fonts, electronic forms, graphics, image, lines, boxes, and bar codes). The AFP MO:DCA data stream includes architected, structured fields that describe each of these elements.

At processing block 320, secondary print server 108 downloads the processed data from primary server 107. At processing block 330, the designated local server 108 immediately begins to segment and forward the print the job to a selected printer 109 upon completing the download. In one embodiment, local print server 108 segment the downloaded print job by converting the data to an Intelligent Printer Data Stream (IPDS) for communication with printers 109.

The IPDS data stream is similar to the AFP data steam, but is built specific to the destination printer 109 in order to integrate with each printer's specific capabilities and command set, and to facilitate the interactive dialog between the local print server 108 and the printer 109. The IPDS data stream may be built dynamically at presentation time (e.g., on-the-fly in real time). Thus, the IPDS data stream is provided according to a device-dependent bi-directional command/data stream.

At processing block 340, local server 108 monitors the status of the print job. If the print job is being printed at network 110, service interface 210 provides the job status to workflow engine 220 with real-time status updates from the time the job is received at local print server 207 to completion. Similarly, workflow engine 220 is configured to monitor the print buffers of printers 109 within network 112 to maintain print status for local jobs.

At decision block 350, it is determined whether the job has been completed. If it is determined that the job has not been completed, control is returned to processing block 330 where the monitoring of the print job status continues. Otherwise the process has been completed.

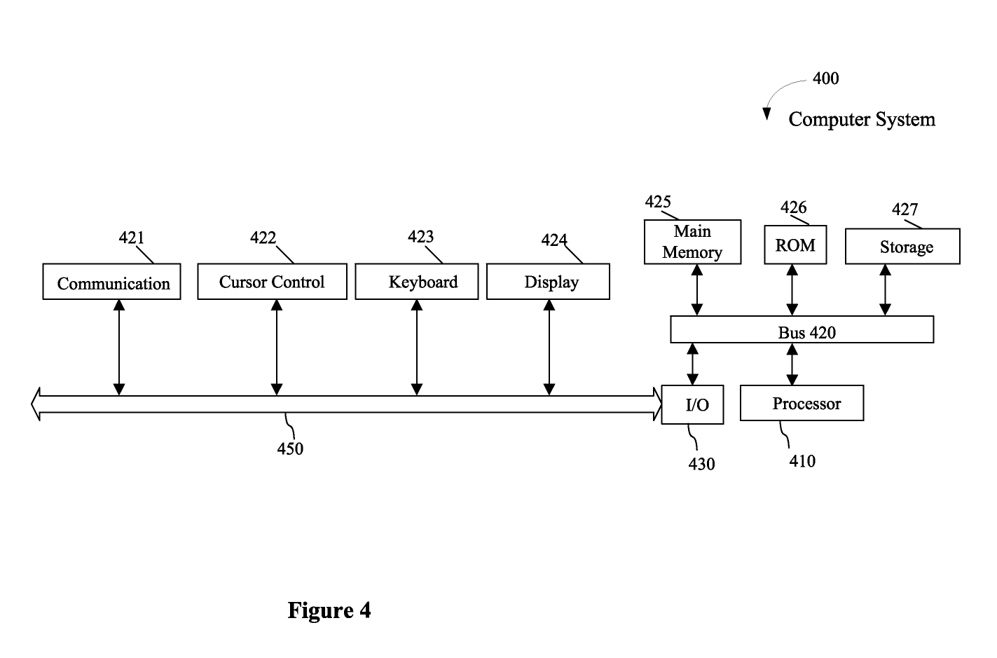

FIG. 4 illustrates a computer system 400 on which data processing system 102 and/or servers 107 and 108 may be implemented. Computer system 400 includes a system bus 420 for communicating information, and a processor 410 coupled to bus 420 for processing information.

Computer system 400 further comprises a random access memory (RAM) or other dynamic storage device 425 (referred to herein as main memory), coupled to bus 420 for storing information and instructions to be executed by processor 410. Main memory 425 also may be used for storing temporary variables or other intermediate information during execution of instructions by processor 410. Computer system 400 also may include a read only memory (ROM) and or other static storage device 426 coupled to bus 420 for storing static information and instructions used by processor 410.

A data storage device 425 such as a magnetic disk or optical disc and its corresponding drive may also be coupled to computer system 400 for storing information and instructions. Computer system 400 can also be coupled to a second I/O bus 450 via an I/O interface 430. A plurality of I/O devices may be coupled to I/O bus 450, including a display device 424, an input device (e.g., an alphanumeric input device 423 and or a cursor control device 422). The communication device 421 is for accessing other computers (servers or clients). The communication device 421 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a local computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A method comprising:
receiving print job data at a cloud computing network server;
determining if the print job data is to be printed at a printer within a client printing network or a printer within a third-party printing network;
downloading the print job data to a local print server in the client printing network if the print job data is to be printed at the client printing network; and
downloading the print job data to a local print server in the third-party printing network if the print job data is to be printed at the third-party printing network.

2. The method of claim 1 wherein receiving print job data at the cloud computing network server comprises receiving an indication of a destination printing network at which the print job data is to be printed.

3. The method of claim 1 further comprising monitoring a printing status of the print job data.

4. The method of claim 3 wherein monitoring the printing status comprises receiving status data from the third-party printing network.

5. The method of claim 3 wherein monitoring the printing status comprises monitoring print buffers of a printer within the client printing network at which the print job data is being printed.

6. A workflow server, comprising a workflow engine to receive print job data via a cloud computing network, download the print job data to a local print server in a client printing network if the print job data indicates that it is to be printed at the client printing network and download the print job data to a local print server in a third-party printing network if the print job data indicates that it is to be printed at the third-party printing network.

7. The workflow server of claim 6 further comprising a service interface communicatively coupled to the third-party printing network to monitor a printing status of the print job data.

8. The workflow server of claim 7 wherein the service interface is communicatively coupled to the third-party printing network via an application programming interface (API).

9. The workflow server of claim 7 wherein the service interface is communicatively coupled to the third-party printing network via a file based architecture.

10. The workflow server of claim 7 wherein the workflow engine monitors the printing status within the client printing network by monitoring print buffers of a printer at which the print job data is being printed.

11. A printing system, comprising:
a client printing network;
a third-party printing network; and
a cloud computing server coupled to the client printing network and the third-party printing network, having a workflow engine to receive print job data from the client printing network, download the print job data to the client printing network if the print job data indicates that it is to be printed at the client printing network and download the print job data to the third-party printing network if the print job data indicates that it is to be printed at the third-party printing network.

12. The printing system of claim 11 wherein the cloud computing server further comprising a service interface communicatively coupled to the third-party printing network to monitor a printing status of the print job data.

13. The printing system of claim 12 wherein the service interface is communicatively coupled to the third-party printing network via an application programming interface (API).

14. The printing system of claim 12 wherein the service interface is communicatively coupled to the third-party printing network via a file based architecture.

15. The printing system of claim 12 wherein the client printing network comprises:
a client computer having a graphical user interface (GUI);
a local print server to receive the print job data from the cloud computing server; and
one or more printers to apply the print job data to a medium;

16. The printing system of claim 15 wherein the GUI comprises a console to enable an operator at the client computer to interface with the workflow engine.

17. The printing system of claim 15 wherein the client computer interfacing with the workflow engine comprises receiving updates of printing status of the print job data being printed at the third-party printing network.

18. The printing system of claim 15 wherein the third-party printing network comprises:
a local print server to receive the print job data from the cloud computing server; and
one or more printers to apply the print job data to a medium;

19. The printing system of claim 18 wherein third-party printing network comprises further comprises an interface communicatively coupled to the service interface.

20. An article of manufacture comprising a machine-readable medium including data that, when accessed by a machine, cause the machine to perform operations comprising:
receiving print job data at a cloud computing network server;
determining if the print job data is to be printed at a printer within a client printing network or a printer within a third-party printing network;
downloading the print job data to a local print server in the client printing network if the print job data is to be printed at the client printing network; and
downloading the print job data to a local print server in the third-party printing network if the print job data is to be printed at the third-party printing network.

21. The article of manufacture of claim 20 wherein receiving print job data at the cloud computing network server comprises receiving an indication of a destination printing network at which the print job data is to be printed.

22. The article of manufacture of claim 20 comprising a machine-readable medium including data that, when accessed by a machine, further cause the machine to perform operations comprising monitoring a printing status of the print job data.

23. The article of manufacture of claim 22 wherein monitoring the printing status comprises receiving status data from the third-party printing network.

24. The article of manufacture of claim 22 wherein monitoring the printing status comprises monitoring print buffers of a printer within the client printing network at which the print job data is being printed.
